(19) United States
(12) Patent Application Publication
(10) Pub. No.: US 2018/0278537 A1
(43) Pub. Date: Sep. 27, 2018

(54) DATA COMMUNICATION DEVICE, METHOD FOR CONTROLLING DATA COMMUNICATION, AND PROGRAM

(71) Applicant: NEC Corporation, Minato-ku, Tokyo (JP)

(72) Inventor: Satoru AMANO, Tokyo (JP)

(73) Assignee: NEC Corporation, Minato-ku, Tokyo (JP)

(21) Appl. No.: 15/762,151

(22) PCT Filed: Sep. 23, 2016
(86) PCT No.: PCT/JP2016/077990

§ 371 Date: Mar. 22, 2018

(30) Foreign Application Priority Data
Sep. 25, 2015 (JP) 2015-188491

(51) Int. Cl. H04L 12/863; H04L 29/08; H04L 12/861; H04L 12/26

(52) U.S. Cl. CPC H04L 47/50; H04L 67/28; H04L 69/16; H04L 43/0894; H04L 49/90

(57) ABSTRACT

A data communication device includes: a reception unit that receives data from a transmission device; a transmission unit that transmits the data to a reception device; a setting unit that sets, when the reception unit starts to receive the data, an amount of the data received by the reception unit to an amount that is independent from a transmission speed of the data from the transmission unit to the reception device; an updating unit that updates the set amount to an amount that corresponds to the transmission speed after the reception unit has received the set amount of the data; and a suppression unit that interrupts the transmission device from transmitting the data until the transmission unit transmits the updated amount of the data after the reception unit has received the updated amount of the data.

### TECHNICAL FIELD

The present invention relates to a data communication device, a method for controlling data communication, and a program.

### BACKGROUND ART

There is known a technique of providing a proxy server device for the purpose of improving the throughput in a communication method, such as TCP/IP, which sets a window size (an amount of data that can be transmitted without receiving an acknowledgment response (ACK: Acknowledgement)).

As a specific example, a proxy server device is provided between a content server device and a client device. In a downlink communication (communication from the server device to the client device), the window size of the proxy server device is set larger than the window size of the client device. Consequently, data from the content server device can be buffered in the proxy server device. Furthermore, when seen from the client device, the proxy server device is provided on the client device side of the content server device. As a result, the communication throughput between the client device and the proxy server device becomes shorter than the communication throughput between the client device and the content server device. Consequently, communications can be accelerated (the throughput can be improved) between the client device and the content server device.

When a communication between the proxy server device and the client device becomes disconnected in a state where the proxy server device has buffered data from the content server device, the data buffered by the proxy server device is wasted. Therefore, the communication bandwidth between the content server device and the proxy server device is wasted.

In order to reduce such a waste of communication bandwidth, it is necessary to control the amount of data buffered by the proxy server, and several techniques for doing so have been proposed. For example, in the data communication device described in Patent Document 1, a TCP module determines the maximum amount of a transmission buffer based on a congestion window (cwnd). Further, the TCP module determines the window size to be notified to a transmission terminal according to the amount of data that is to be held by the transmission buffer.

As a result, according to Patent Document 1, the data communication device does not accumulate a large amount of data despite a large delay occurring in a reception terminal, the occurrence of an unexpected transfer delay between end-end terminals can be avoided, and further, tightness in the buffer capacity can also be alleviated.

### PRIOR ART DOCUMENTS

### Patent Document

[Patent Document 1] Japanese Unexamined Patent Application, First Publication No. 2005-348107

### DISCLOSURE OF THE INVENTION

### Problem to be Solved by the Invention

As a result of providing a data communication device (for example, a proxy server device), communication between a transmission device (for example, a content server device) and a reception device (for example, a client device) is accelerated. In this case, in addition to effectively utilizing the communication bandwidth between the transmission device and the data communication device, it is preferable to reduce delays in data transmission from the data communication device to the reception device.

In particular, in a communication requiring a real time property such as streaming distribution of a moving image, there is a possibility that a malfunction will occur such as a delay in playback of the moving image by the reception device when data transmission from the data communication device to the reception device is delayed. Therefore, in a communication requiring a real time property, it is particularly desirable to reduce delays in data transmission from the data communication device to the reception device.

An exemplary object of the present invention is to provide a data communication device, a method for controlling data communication, and a program capable of solving the above problems.

### Means for Solving the Problem

According to a first exemplary aspect of the present invention, a data communication device includes: a reception unit that receives data from a transmission device; a transmission unit that transmits the data to a reception device; a setting unit that sets, when the reception unit starts to receive the data, an amount of the data received by the reception unit to an amount that is independent from a transmission speed of the data from the transmission unit to the reception device; an updating unit that updates the set amount to an amount that corresponds to the transmission speed after the reception unit has received the set amount of the data; and a suppression unit that interrupts the transmission device from transmitting the data until the transmission unit transmits the updated amount of the data after the reception unit has received the updated amount of the data.

According to a second exemplary aspect of the present invention, a method for controlling data communication includes: receiving, by a reception unit, data from a transmission device; transmitting, by a transmission unit, the data to a reception device; setting, when the reception unit starts to receive the data, an amount of the data received by the reception unit to an amount that is independent from a transmission speed of the data from the transmission unit to the reception device; updating the set amount to an amount that corresponds to the transmission speed after the reception unit has received the set amount of the data; and interrupting the transmission device from transmitting the data until the transmission unit transmits the updated amount of the data after the reception unit has received the updated amount of the data.

According to a third exemplary aspect of the present invention, a program causes a computer that controls a data communication device including a reception unit that receives data from a transmission device and a transmission unit that transmits the data to a reception device, to execute: setting, when the reception unit starts to receive the data, an amount of the data received by the reception unit to an amount that is independent from a transmission speed of the data from the transmission unit to the reception device; updating the set amount to an amount that corresponds to the transmission speed after the reception unit has received the set amount of the data; and interrupting the transmission device from transmitting the data until the transmission unit transmits the updated amount of the data after the reception unit has received the updated amount of the data.

### Effect of the Invention

According to the present invention, it is possible to effectively utilize the communication bandwidth between a transmission device and a data communication device, and delays in data transmission from the data communication device to a reception device can be reduced.

### BRIEF DESCRIPTION OF THE DRAWINGS

FIG. 1 is a schematic block diagram showing a functional configuration of a communication system according to an exemplary embodiment of the present invention.

FIG. 2 is an explanatory diagram showing a hierarchical structure of a proxy server device of the communication system shown in FIG. 1.

FIG. 3 is a schematic block diagram showing a functional configuration of the proxy server device shown in FIG. 2.

FIG. 4 is an explanatory diagram of the capacity of a transmission buffer of the proxy server device shown in FIG. 3.

FIG. 5 is a flowchart showing a procedure of the processing performed by the proxy server device shown in FIG. 3.

FIG. 6 is an explanatory diagram showing an example of the amount of data in a reception buffer and the transmission buffer in step S102 in FIG. 5, in a state before data has been read.

FIG. 7 is an explanatory diagram showing an example of the amount of data in the reception buffer and the transmission buffer in step S102 in FIG. 5, in a state after data has been read and stored.

FIG. 8 is an explanatory diagram showing an example where the accumulation amount in the transmission buffer shown in FIG. 4 is smaller than a re-reception threshold.

FIG. 9 is an explanatory diagram showing an example of the amount of data in the reception buffer in step S112 in FIG. 5, in a state before data has been read.

FIG. 10 is an explanatory diagram showing an example of the amount of data in the reception buffer and the transmission buffer in step S112 in FIG. 5, in a state after data has been read and stored.

FIG. 11 is a schematic block diagram showing a configuration of a data communication device according to an exemplary embodiment of the present invention.

### EMBODIMENTS FOR CARRYING OUT THE INVENTION

Hereunder, an exemplary embodiment of the present invention will be described. However, the following exemplary embodiment in no way limits the invention according to the claims. Furthermore, not all combinations of the features described in the exemplary embodiment are necessarily essential to the solution means of the invention.

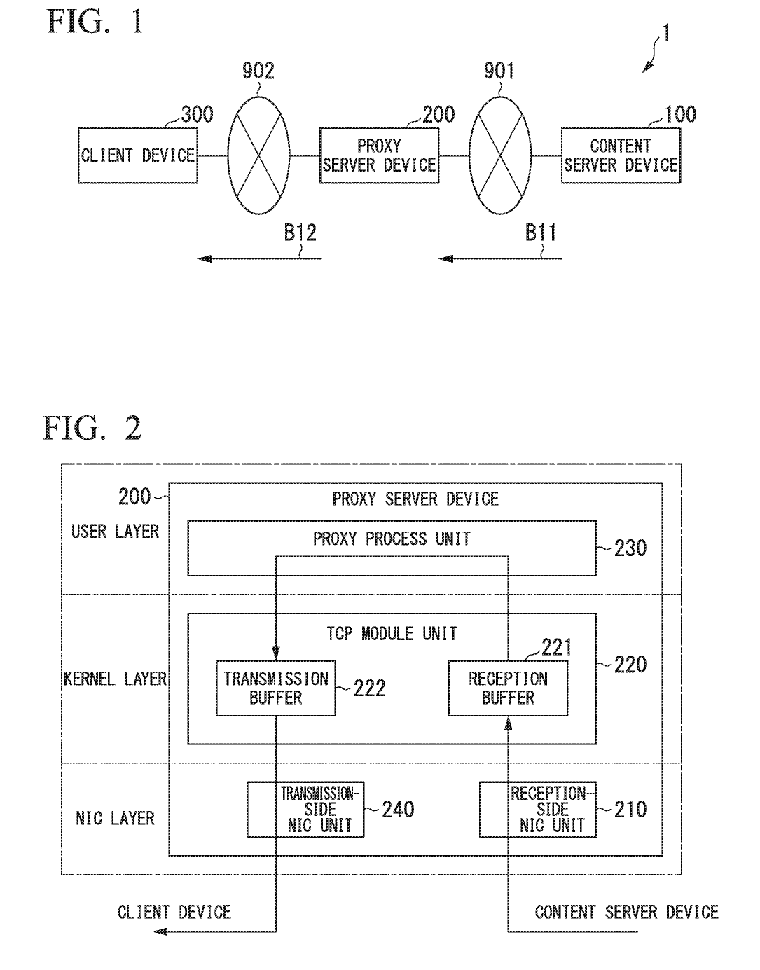

FIG. 1 is a schematic block diagram showing a functional configuration of a communication system according to an exemplary embodiment of the present invention. As shown in FIG. 1, the communication system 1 includes a content server device 100, a proxy server device 200, and a client device 300.

The content server device 100 and the proxy server device 200 perform communication with each other via a global network 901. The proxy server device 200 and the client device 300 perform wireless communication with each other via a mobile network 902.

The number of client devices 300 included in the communication system 1 is not limited to one as shown in FIG. 1, and a plurality may be provided. The number of proxy server devices 200 included in the communication system 1 is not limited to one as shown in FIG. 1, and a plurality may be provided. The number of content server devices 100 included in the communication system 1 is not limited to one as shown in FIG. 1, and a plurality may be provided.

In the example shown in FIG. 1, a state in which a communication path has been established between a single client device 300 and a single content server device 100 is shown. Arrow B11 and arrow B12 both indicate a downstream direction. As indicated by the arrow B11 and the arrow B12, the communication system 1 transmits content data from the content server device 100 to the client device 300 via the global network 901, the proxy server device 200, and the mobile network 902.

The content referred to here is a moving image, a still image, audio or text, or a combination of these. The content data referred to here is data representing the content.

The data transmitted by the communication system 1 is in no way limited to content data, and may represent various types of data.

The communication system 1 is a communication system that transmits content data from the content server device 100 to the client device 300.

The content server device 100 stores content data and transmits content data in response to a request from the client device 300. The content server device 100 is configured as a server device using a computer. The content server device 100 corresponds to an example of a transmission device.

The proxy server device 200 is a device provided for accelerating communication between the content server device 100 and the client device 300. Specifically, the communication system 1 performs communication by TCP/IP (Transmission Control Protocol/Internet Protocol), and the proxy server device 200 is installed as a TCP proxy server device (PEP: Performance Enhanced Proxy). In particular, the window size of the proxy server device 200 (an amount of data that can be transmitted without receiving an acknowledgment (ACK: Acknowledgment)) is larger than the window size of the client device 300. As a result, the amount of data that the content server device 100 can transmit without waiting for reception of an ACK becomes larger than in a case where the content server device 100 performs direct communication with the client device 300. In this regard, it is possible to accelerate communication between the content server device 100 and the client device 300.

However, the communication method of the communication system 1 is in no way limited to TCP/IP, and may be any communication method that sets the amount of data that can be transmitted without receiving an acknowledgment.

The proxy server device 200 is configured as a server device using a computer. The proxy server device 200 corresponds to an example of a data communication device.

The client device 300 requests the content server device 100 to transmit content data, and it receives the content data transmitted by the content server device 100. In the following, an example of a case where the client device 300 performs wireless communication will be described as an example in which the latency of communication performed by the client device 300 can change. However, the client device 300 may perform communication by wired communication.

The client device 300 is configured as a terminal device using an information processing device (computer) such as a smartphone or a personal computer. The client device 300 corresponds to an example of a reception device.

The global network 901 mediates communication between the content server device 100 and the proxy server device 200. The global network 901 may be a general purpose network such as the Internet, or it may be a network dedicated to the communication system 1.

The mobile network 902 mediates communication between the proxy server device 200 and the client device 300. In particular, the client device 300 is connected to the mobile network 902 by wireless communication. However, as described above, the client device 300 may be connected to the mobile network 902 by wired communication.

FIG. 2 is an explanatory diagram showing a hierarchical structure of the proxy server device 200. As shown in the drawing, the proxy server device 200 includes a reception-side NIC unit 210, a TCP module unit 220, a proxy process unit 230, and a transmission-side NIC unit 240. The TCP module unit 220 includes a reception buffer 221 and a transmission buffer 222.

FIG. 2 shows a functional configuration in which the proxy server device 200 performs communication on a downlink side (from the content server device 100 to the client device 300). However, the present exemplary embodiment is in no way limited to the example shown in FIG. 2. The proxy server device 200 may also perform communication on an uplink side (from the client device 300 to the content server device 100).

The reception-side NIC unit 210 is a physical interface through which the proxy server device 200 performs communication with the global network 901. In particular, the reception-side NIC unit 210 outputs signals received from the global network 901 to the TCP module unit 220.

The TCP module unit 220 executes TCP.

The reception buffer 221 temporarily stores (buffers) data received from the content server device 100 by FIFO (First In First Out).

The transmission buffer 222 temporarily stores transmission data to the client device 300 by FIFO.

The proxy process unit 230 controls an application program executed by the proxy server device 200. In particular, the proxy process unit 230 reads data from the reception buffer 221 and stores it in the transmission buffer 222.

The transmission-side NIC unit 240 is a physical interface through which the proxy server device 200 performs communication with the mobile network 902. In particular, the transmission-side NIC unit 240 transmits signals output from the TCP module unit 220 to the mobile network 902.

When classifying the functional configuration of the proxy server device 200 into three layers, the reception-side NIC unit 210 and the transmission-side NIC unit 240 are included in an NIC layer, the TCP module unit 220 is included in a kernel layer, and the proxy process unit 230 is included in a user layer. The NIC layer is a physical layer (a layer that performs communication at the hardware level). The kernel layer is a layer in which the kernel of an OS (Operating System) performs processing. The user layer is a layer that executes an application program.

FIG. 2 shows an example where the proxy server device 200 separately includes the reception buffer 221 and the transmission buffer 222. However, the present exemplary embodiment is in no way limited to the example shown in FIG. 2. The proxy server device 200 may use a single buffer for both the reception buffer 221 and the transmission buffer 222.

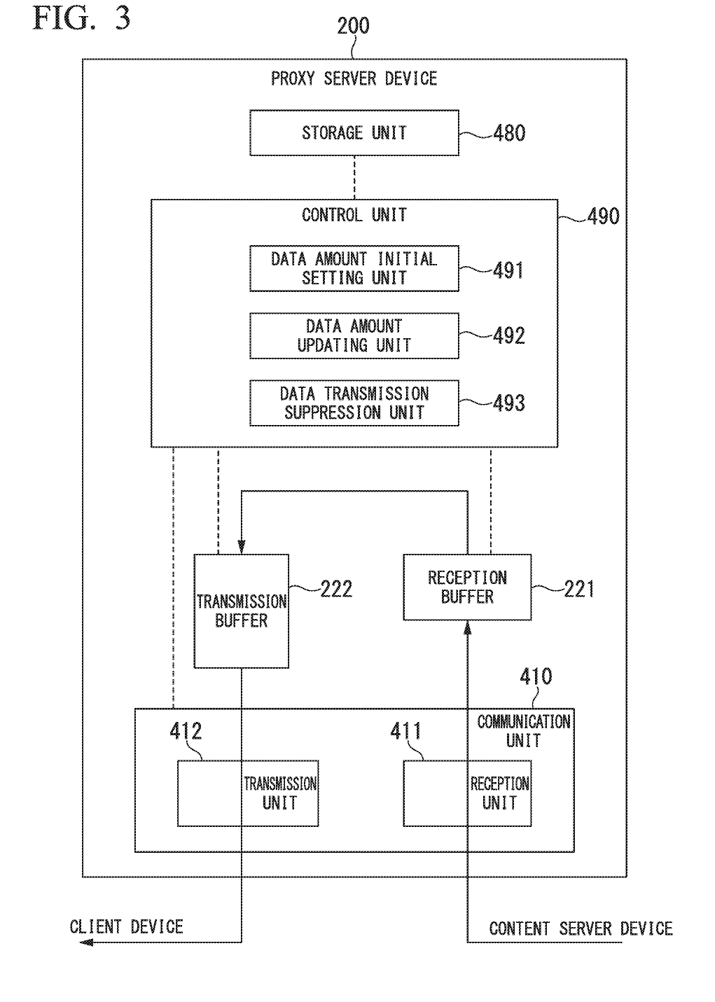

FIG. 3 is a schematic block diagram showing a functional configuration of the proxy server device 200. As shown in FIG. 3, the proxy server device 200 includes a reception buffer 221, a transmission buffer 222, a communication unit 410, a storage unit 480, and a control unit 490. The communication unit 410 includes a reception unit 411 and a transmission unit 412. The control unit 490 includes a data amount initial setting unit 491, a data amount updating unit 492, and a data transmission suppression unit 493. The data amount initial setting unit 491 may be simply referred to as a setting unit 491. The data amount updating unit 492 may be simply referred to as an updating unit 492. The data transmission suppression unit 493 may be simply referred to as a suppression unit 493.

Among the units in FIG. 3, sections having the same functions corresponding to the units in FIG. 2 are given the same reference symbols (200, 221, and 222), and the description is omitted.

The communication unit 410 performs communication with the content server device 100 and the client device 300.

The reception unit 411 corresponds to the reception-side NIC unit 210 in FIG. 2, and receives content data transmitted by the content server device 100.

The transmission unit 412 corresponds to the transmission-side NIC unit 240 in FIG. 2, and transmits content data to the client device 300.

The storage unit 480 is configured using a storage device provided in the proxy server device 200, and stores various types of data. The reception buffer 221 and the transmission buffer 222 may be configured as part of the storage unit 480.

The control unit 490 controls the units of the proxy server device 200 to execute various functions. The control unit 490 is configured, for example, by a CPU (Central Processing Unit) provided in the proxy server device 200 reading a program from the storage unit 480, and then executing it. The control unit 490 corresponds to the TCP module unit 220 and the proxy process unit 230 in FIG. 2.

At the start of data reception by the reception unit 411, the setting unit 491 sets an amount of the data received by the reception unit 411 to an amount of data that is independent from the transmission speed of the data from the transmission unit 412 to the client device 300. Here, the amount of data that is independent from the transmission speed of the data is an amount of data which is fixed irrespective of differences in the transmission speed of the data from the transmission unit 412 to the client device 300.

The setting unit 491 sets the amount of data described above, thereby ensuring a certain amount of data is in the transmission buffer 222 irrespective of the transmission speed of the data from the transmission unit 412 to the client device 300. Consequently, it is possible to reduce the possibility of a deficiency in transmission data from the proxy server device 200 to the client device 300 when the communication status between the proxy server device 200 and the client device 300 improves and causes an improvement in the communication speed. In this regard, it is possible to reduce delays in data transmission from the proxy server device 200 to the client device 300.

After the reception unit 411 receives the data corresponding to the amount of data set by the setting unit 491, the updating unit 492 updates the set value of the amount of the data received by the reception unit 411 to an amount of data corresponding to the transmission speed of the data from the transmission unit 412 to the client device 300. In particular, each time the reception unit 411 receives data corresponding to the amount of data that has been updated by the updating unit 492, and the transmission unit 412 transmits data corresponding to the amount of data thereof, the updating unit 492 updates the amount of the data received by the reception unit 411 to an amount of data corresponding to the transmission speed of the data from the transmission unit 412 to the client device 300.

The updating unit 492 updates the set value of the amount of data described above, thereby making the amount of data received by the reception unit 411 an amount of data that corresponds to the amount of data transmitted by the transmission unit 412. Consequently, it is possible to reduce the possibility of an overflow in the reception buffer 221 or the transmission buffer 222 that causes the proxy server device 200 to discard data. In this regard, it is possible to effectively utilize the communication bandwidth between the content server device 100 and the proxy server device 200.

After the reception unit 411 receives the data corresponding to the amount of data updated by the updating unit 492, the suppression unit 493 suppresses data transmission by the content server device 100 until the transmission unit 412 transmits data corresponding to the amount of data thereof (that is to say, it stops data transmission by the content server device 100). In particular, each time the updating unit 492 updates the set value of the amount of the data received by the reception unit 411, then after the reception unit 411 has received data corresponding to the updated amount of data, the suppression unit 493 suppresses data transmission by the content server device 100 until the transmission unit 412 has transmitted data corresponding to the amount of data thereof.

The suppression unit 493 suppresses data transmission as described above, thereby suppressing (stopping) the content server device 100 from transmitting data corresponding to an amount of data larger than the amount of data that can be processed by proxy server device 200. For example, as described above, it is possible avoid an overflow in the reception buffer 221 or the transmission buffer 222 that causes the proxy server device 200 to discard data. In this regard, it is possible to effectively utilize the communication bandwidth between the content server device 100 and the proxy server device 200.

In addition, the suppression unit 493 suppresses data transmission as described above. Consequently, when a disconnection occurs during communication between the proxy server device 200 and the client device 300, it is possible to reduce the amount of content data transmitted by the content server device 100 to proxy server device 200, that the proxy server device 200 discards without transmission to the client device 300. In this regard, it is possible to effectively utilize the communication bandwidth between the content server device 100 and the proxy server device 200.

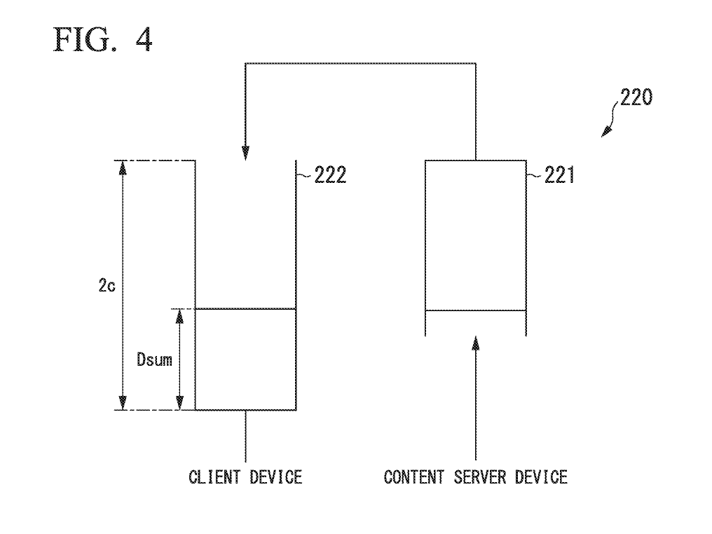

FIG. 4 is an explanatory diagram of the capacity of the transmission buffer 222. As shown in FIG. 4, the data received by the proxy server device 200 from the content server device 100 is stored in the reception buffer 221. Then, the control unit 490 (proxy process unit 230) reads the data from the reception buffer 221 and stores the data thereof in the transmission buffer 222. In the example shown in FIG. 4, the capacity of the transmission buffer 222 (storable amount of data) is indicated by “2c”, and the amount of data stored in the transmission buffer 222 is indicated by “Dsum”. The data stored in the transmission buffer 222 is transmitted to the client device 300.

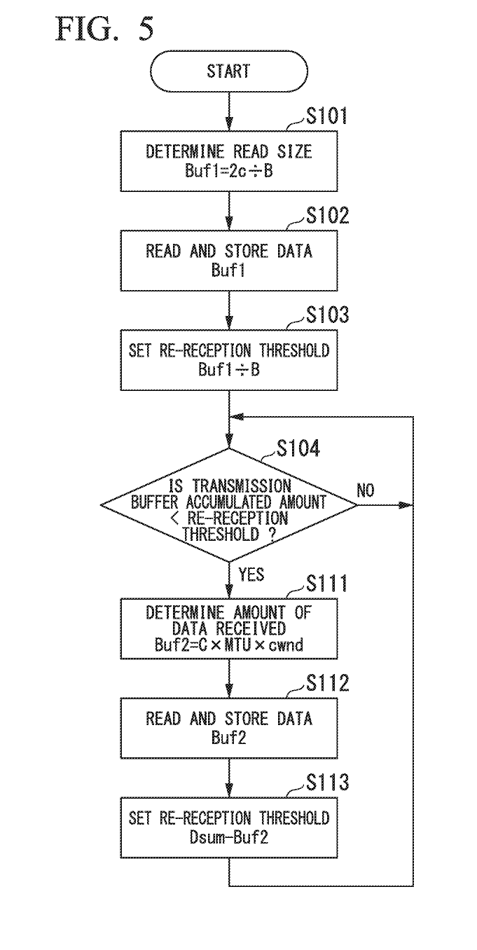

Next, an operation of the proxy server device 200 will be described with reference to FIG. 5.

FIG. 5 is a flowchart showing a procedure of the processing performed by the proxy server device 200. The proxy server device 200, for example, starts the processing of FIG. 5 when communication with the content server device 100 is established and reception of content data will be started.

In the processing of FIG. 5, the setting unit 491 determines a read size from the content server device 100 (amount of data to be received from the content server device 100) based on a transmission buffer size (size (capacity) of the transmission buffer 222) (step S101).

Specifically, the setting unit 491 (proxy process unit 230) calculates a read size Buf1 from the content server device 100 based on equation (1).

[Equation 1]

Buf1=2c÷B (1)

The size of the transmission buffer 222 (amount of data storable in the transmission buffer 222) is represented by “2c”. “B” represents a positive constant. For example, “B” uses a value of 2 (default value).

Buf1 represents an initial read size from content server device 100. Specifically, when the proxy server device 200 establishes communication with the content server device 100 and starts reception of the content data, it waits at step S101 until it receives content data corresponding to the read size Buf1 and stores it in the reception buffer 221.

The read size Buf1 corresponds to an example of the amount of data that is independent from the transmission speed of the data from the transmission unit 412 to the client device 300.

When the reception unit 411 receives the content data corresponding to the read size Buf1 from the content server device 100, the suppression unit 493 causes the content server device 100 to interrupt transmission of content data. The suppression unit 493 can use an existing method such as a zero window notification, as a method of notifying the content server device 100 to interrupt transmission of the content data. As an alternative method, a dedicated signal for indicating that reading of the data corresponding to the read size has been completed can be determined beforehand, and the suppression unit 493 can transmit the signal thereof to the content server device 100 via the communication unit 410.

Then, the control unit 490 (proxy process unit 230) reads the data corresponding to the read size Buf1 determined in step S101 from the reception buffer 221, and stores it in the transmission buffer 222 (step S102).

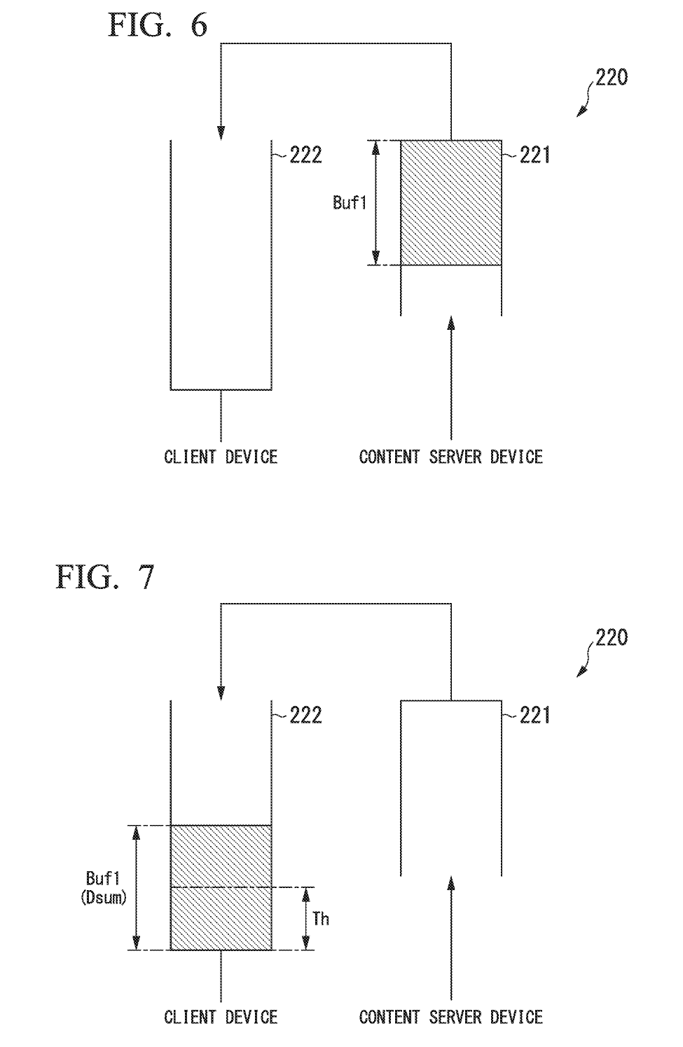

FIG. 6 is an explanatory diagram showing an example of the amount of data in the reception buffer 221 and the transmission buffer 222 in step S102 in FIG. 5, in a state before data has been read. As shown in FIG. 2, the control unit 490 (proxy process unit 230) reads data corresponding to Buf1 stored in the reception buffer 221 by FIFO (that is to say, in order from the earliest timing of storage in the reception buffer). In the example of FIG. 6, the amount of data stored in the transmission buffer 222 is zero.

FIG. 7 is an explanatory diagram showing an example of the amount of data in the reception buffer 221 and the transmission buffer 222 in step S102, in a state after data has been read and stored.

In the example shown in FIG. 7, the data corresponding to the amount of data read from the reception buffer 221 (read size Buf1) by the control unit 490 (proxy process unit 230) is stored in the transmission buffer 222. In addition, a re-reception threshold Th is set with respect to the amount of data in the transmission buffer 222.

In the example shown in FIG. 7, the data corresponding to the amount of data (read size Buf1) stored in the reception buffer 221 has been completely read. Therefore, the amount of data stored in the reception buffer 221 is zero.

When data is stored in the transmission buffer 222, the control unit 490 (TCP module unit 220) transmits the data thereof to the client device 300 via the transmission unit 412. At that time, it is not necessary for the control unit 490 to synchronize with data reception from the content server device 100 and data transfer from the reception buffer 221 to the transmission buffer 222. That is to say, when data is stored in the transmission buffer 222, the control unit 490 transmits the data stored in the transmission buffer 222 to the client device 300 via the transmission unit 412 irrespective of whether data is being received from the content server device 100. Furthermore, when data is stored in the transmission buffer 222, the control unit 490 transmits the data stored in the transmission buffer 222 to the client device 300, irrespective of whether the data is being transferred from the reception buffer 221 to the transmission buffer 222.

The control unit 490 (proxy process unit 230) sets a re-reception threshold value (step S103). For example, when the value of the constant B is 2, the control unit 490 calculates a re-reception threshold value Th based on equation (2). Consequently, the control unit 490 sets the re-reception threshold value Th to a size less than or equal to the read size Buf1.

[Equation 2]

Th=Buf1÷B (2)

As a result of setting the re-reception threshold Th to a size less than or equal to the read size Buf1, the re-reception threshold Th becomes a value less than or equal to the amount of data stored in the transmission buffer 222.

After step S103, the control unit 490 (TCP module unit 220) determines whether or not the accumulation amount in the transmission buffer 222 (the amount of data stored in the transmission buffer 222) is smaller than the re-reception threshold value Th (step S104).

When the control unit 490 determines that the accumulation amount in the transmission buffer 222 is more than or equal to the re-reception threshold Th (step S104:NO), the processing returns to step S104.

When the control unit 490 determines that the accumulation amount of the transmission buffer 222 is smaller than the re-reception threshold Th (step S104:YES), the updating unit 492 (proxy process unit 230) calculates a read size Buf2 from the content server device 100 based on equation (3) (step S111).

[Equation 3]

Buf2=C×MTU×cwnd (3)

“C” represents a positive constant. For example, “C” uses a value of 2 (default value). “MTU” represents a constant indicating the maximum size of an IP packet. “cwnd” represents a congestion window. “cwnd” represents the size of the congestion window in number of packets. In equation (3), “MTU×cwnd” represents the size of the congestion window in terms of data size (for example, in byte units).

The control unit 490 (TCP module unit 220) increases or decreases the congestion window according to variations in the delay between the proxy server device 200 and the client device 300. For example, based on a measurement of the delay between the proxy server device 200 and the client device 300, the control unit 490 decreases the congestion window if the delay increases, and increases the congestion window if the delay decreases. Furthermore, the control unit 490 decreases the congestion window when a packet transmitted to the client device 300 is lost.

In this manner, the size of the congestion window cwnd is set according to the transmission speed of the data from the transmission unit 412 to the client device 300, and is set to a larger value as the transmission speed becomes higher. The read Buf2 corresponds to an example of the amount of data corresponding to the transmission speed of the data from the transmission unit 412 to the client device 300.

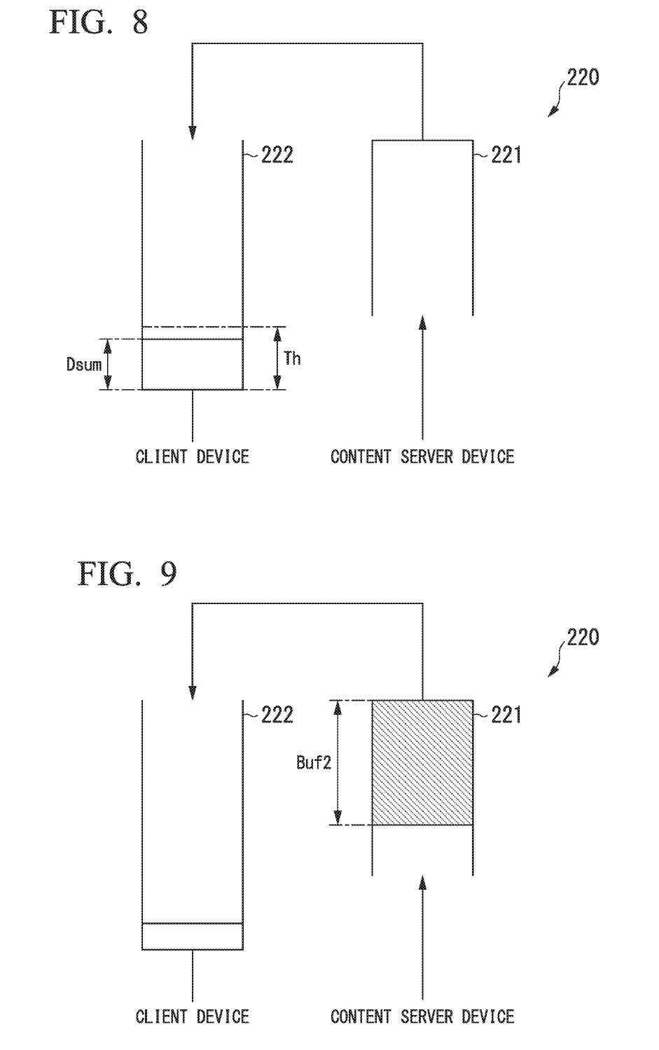

FIG. 8 is an explanatory diagram showing an example in which the accumulation amount in the transmission buffer 222 is smaller than the re-reception threshold Th. In the example of FIG. 8, the accumulation amount Dsum in the transmission buffer 222 (the amount of data stored in the transmission buffer 222) is smaller than the re-reception threshold Th.

After step S111, the control unit 490 (proxy process unit) 230 reads the data corresponding to the read size Buf2 determined in step S111 from the reception buffer 221, and stores it in the transmission buffer 222 (step S112).

Specifically, the proxy server device 200 (suppression unit 493) requests the content server device 100 to transmit content data. Then, the reception unit 411 receives the content data corresponding to the read size Buf2, and the control unit 490 stores the content data received by the reception unit 411 in the reception buffer 221. Upon receiving the content data corresponding to the read size Buf2, the proxy server device 200 (suppression unit 493) causes the content server device 100 to interrupt transmission of the content data. Then, the control unit 490 (proxy process unit 230) reads the content data corresponding to the read size Buf2 from the reception buffer 221, and stores it in the transmission buffer 222.

Next, the control unit 490 (proxy process unit 230) resets the re-reception threshold Th (step S113). For example, the control unit 490 calculates the re-reception threshold value Th based on equation (4).

[Equation 4]

Th=Dsum−Buf2 (4)

Here, Dsum represents the amount of data currently held by the transmission buffer 222 (that is to say, the amount of data stored in the transmission buffer 222).

FIG. 9 is an explanatory diagram showing an example of the amount of data in the reception buffer 221 in step S112, in a state before data has been read. As shown in FIG. 9, the control unit 490 (proxy process unit 230) reads data corresponding to Buf2 among the data stored in the reception buffer 221 by FIFO.

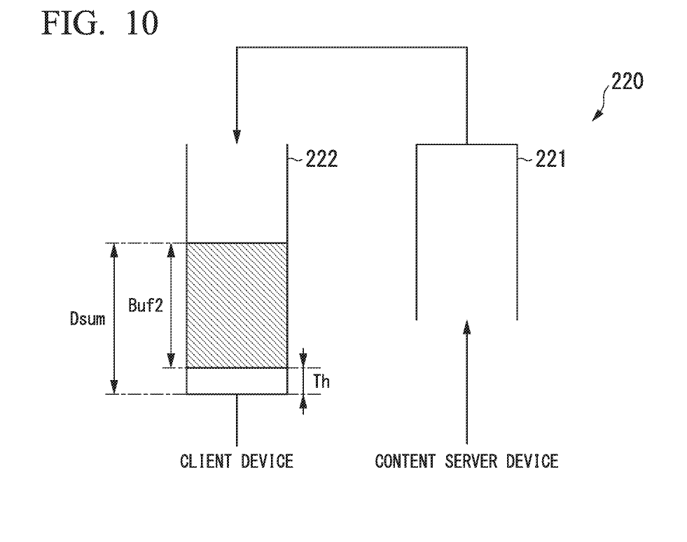

FIG. 10 is an explanatory diagram showing an example of the amount of data in the reception buffer 221 and the transmission buffer 222 in step S112 in a state after data has been read and stored.

In the example of FIG. 10, the data corresponding to the amount of data read from the reception buffer 221 (read size Buf2) by the control unit 490 (proxy process unit 230) is stored in the transmission buffer 222.

Furthermore, the re-reception threshold Th is set with respect to the amount of data in the transmission buffer 222. Here, the re-reception threshold value Th is set to an amount of data obtained by subtracting the read size Buf2 from the amount of data Dsum stored in the transmission buffer 222.

After step S113, the processing returns to step S104.

In this manner, based on the re-reception threshold Th set in step S112, the control unit 490 (proxy process unit 230) repeats the processing of steps S111 to S113 each time the content data corresponding to the read size Buf2 decreases from the transmission buffer 222. That is to say, the control unit 490 (proxy process unit 230) repeats the setting of the read size Buf2 and the storage of data corresponding to the read size Buf2 in the transmission buffer each time data corresponding to an amount of data equal to the stored data decreases from the transmission buffer 222. As a result, the amount of data in the transmission buffer 222 in step S112 in a state before data has been stored in the transmission buffer 222 (content data) is kept at an approximately constant amount of data.

In a case where a decrease in the amount of data in the transmission buffer 222 cannot be ignored in the interval from the control unit 490 (proxy process unit 230) determining YES in step S104 until the execution of step S113, a constant may be used instead of the amount of data Dsum. For example, the control unit 490 stores the value of the re-reception threshold value Th calculated based on the formula (2) in step S103 as a constant Th1. Then, in step S113, the control unit 490 calculates the re-reception threshold Th using the constant Th1 instead of the amount of data Dsum. That is to say, the control unit 490 calculates the re-reception threshold value Th using the equation “Th=Th1−Buf2”.

As a result, even in the case described above where a decrease in the amount of data cannot be ignored, the amount of data in the transmission buffer 222 in step S112 in a state before data has been stored in the transmission buffer 222, is kept at an approximately constant amount of data.

On the other hand, when the control unit 490 calculates the re-reception threshold value Th by detecting the amount of data Dsum as in equation (4), it is not necessary to store the constant Th1. In this regard, it is possible to reduce the memory capacity of the storage unit 480.

The control unit 490 (proxy process unit 230) may transfer data from the reception buffer 221 to the transmission buffer 222 without waiting for the reception unit 411 to complete reception of the data corresponding to the read size.

Specifically, in step S102, when the reception unit 411 receives the content data and stores it in the reception buffer 221, the control unit 490 may transfer data from the reception buffer 221 to the transmission buffer 222 without waiting for completion of reception of the data corresponding to the read size Buf1. In this case, the control unit 490 detects the amount of the data received by the reception unit 411, and when this received amount of the data reaches the read size Buf1, it causes the content server device 100 to interrupt the transmission of content data.

The amount of the data received by the reception unit 411 can be calculated by the sum of the amount of data stored in the reception buffer 221 and the amount of the data transferred by the control unit 490 from the reception buffer 221 to the transmission buffer 222.

In the same manner, in step S112, when the reception unit 411 receives the content data and stores it in the reception buffer 221, the control unit 490 may transfer data from the reception buffer 221 to the transmission buffer 222 without waiting for completion of reception of the data corresponding to the read size Buf2. In this case, the control unit 490 detects the amount of the data received by the reception unit 411, and when this received amount of the data reaches the read size Buf2, it causes the content server device 100 to interrupt the transmission of content data.

As described above, at the start of data reception by the reception unit 411, the setting unit 491 sets the amount of the data received by the reception unit 411 to an amount of data independent from the transmission speed of the data from the transmission unit 412 to the client device 300 (that is to say, at the start of data reception by the reception unit 411, the setting unit 491 sets an amount of the data received by the reception unit 411 without dependence on the transmission speed of the data from the transmission unit 412 to the client device 300). Furthermore, after the reception unit 411 has received the data corresponding to the amount of data set by the setting unit 491, the updating unit 492 updates the set value of the amount of the data received by the reception unit 411 to an amount of data corresponding to the transmission speed of the data from the transmission unit 412 to the client device 300. Furthermore, after the reception unit 411 receives the data corresponding to the amount of data updated by the updating unit 492, the suppression unit 493 suppresses data transmission by the transmission device until the transmission unit 412 transmits data corresponding to the amount of data thereof.

As a result of the setting unit 491 setting the amount of data as described above, it is possible to ensure a certain amount of data is in the transmission buffer 222 irrespective of the transmission speed of the data from the transmission unit 412 to the client device 300. Consequently, it is possible to reduce the possibility of a deficiency in transmission data from the proxy server device 200 to the client device 300 when the communication status between the proxy server device 200 and the client device 300 improves and causes an improvement in the communication speed. In this regard, according to the proxy server device 200, it is possible to reduce delays in data transmission from the proxy server device 200 to the client device 300.

Furthermore, the suppression unit 493 suppresses data transmission as described above. Consequently, when a disconnection occurs during communication between the proxy server device 200 and the client device 300, it is possible to reduce the amount of content data transmitted by the content server device 100 to the proxy server device 200, that the proxy server device 200 discards without transmission to the client device 300. In this regard, it is possible to effectively utilize the communication bandwidth between the content server device 100 and the proxy server device 200.

In this manner, according to the proxy server device 200, the communication bandwidth between the content server device 100 and the proxy server device 200 can be effectively utilized, and it is possible to reduce delays in data transmission from the proxy server device 200 to the client device 300.

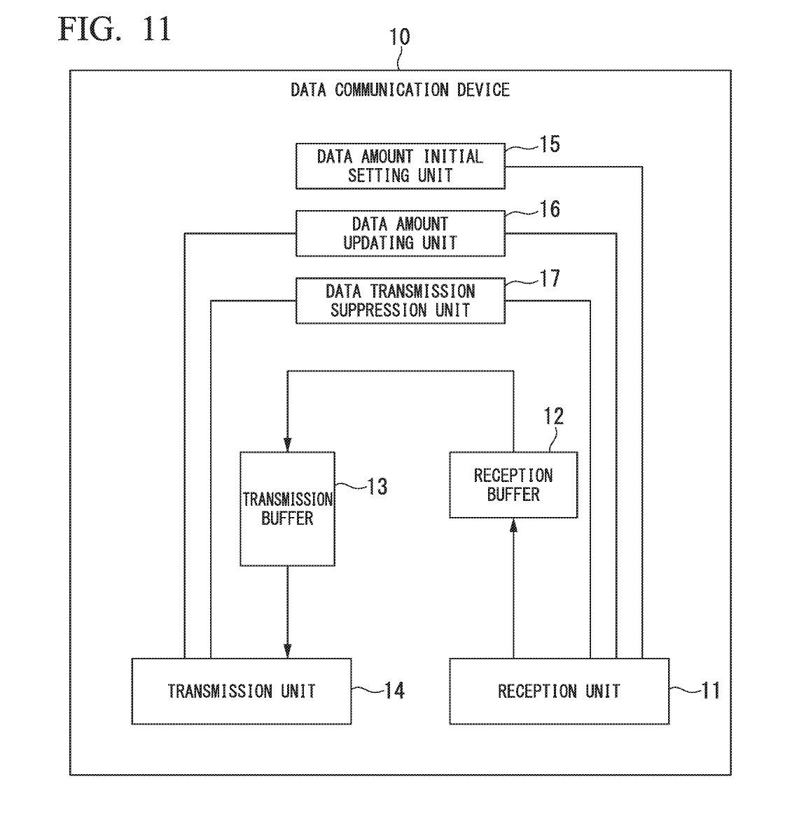

Next, a configuration of the exemplary embodiment of the present invention will be described with reference to FIG. 11.

FIG. 11 is a schematic block diagram showing a configuration of a data communication device according to an exemplary embodiment of the present invention. The data communication device 10 shown in FIG. 11 includes a reception unit 11, a reception buffer 12, a transmission buffer 13, a transmission unit 14, a data amount initial setting unit 15, a data amount updating unit 16, and a data transmission suppression unit 17.

In such a configuration, the reception unit 11 receives data from a transmission device. Then, the transmission unit 14 transmits the data received by the reception unit 11 to a receiving device. The reception buffer 12 stores the data received by the reception unit 11. The transmission buffer 13 stores data awaiting transmission by the transmission unit 14.

At the start of data reception by the reception unit 11, the data amount initial setting unit 15 sets the amount of the data received by the reception unit 11 to an amount of data that is independent from the transmission speed of the data from the transmission unit 14 to the reception device. After the reception unit 11 receives the data corresponding to the amount of data set by the data amount initial setting unit 15, the data amount updating unit 16 updates the set value of the amount of the data received by the reception unit 11 to an amount of data corresponding to the transmission speed of the data from the transmission unit 14 to the reception device. After the reception unit 11 receives the data corresponding to the amount of data updated by the data amount updating unit 16, the data transmission suppression unit suppresses data transmission by the transmission device until the transmission unit 14 transmits data corresponding to the amount of data thereof.

As a result of the data amount initial setting unit 15 setting the amount of data as described above, it is possible to ensure a certain amount of data is in the transmission buffer 13 irrespective of the transmission speed of the data from the transmission unit 14 to the receiving device. Consequently, it is possible to reduce the possibility of a deficiency in transmission data from the data communication device 10 to the reception device when the communication status between the data communication device 10 and the reception device improves and causes an improvement in the communication speed. In this regard, according to the data communication device 10, it is possible to reduce delays in data transmission from the data communication device 10 to the reception device.

Furthermore, the data transmission suppression unit 17 suppresses data transmission as described above. Consequently, when a disconnection occurs during communication between the data communication device 10 and the reception device, it is possible to reduce the amount of data transmitted by the transmission device to the data communication device 10, that the data communication device 10 discards without transmission to the reception device. In this regard, it is possible to effectively utilize the communication bandwidth between the transmission device and the data communication device 10.

In this manner, according to the data communication device 10, the communication bandwidth between transmission device and the data communication device 10 can be effectively utilized, and it is possible to reduce delays in data transmission from the data communication device 10 to the reception device.

Although an exemplary embodiment of the present invention has been described above in detail with reference to the drawings, the specific configuration is in no way limited to this exemplary embodiment, and designs and the like within a scope not deviating from the gist of the present invention are included.

### REFERENCE SYMBOLS

1 Communication system
10, 100 Content server device
11, 411 Reception unit
12, 221 Reception buffer
13, 222 Transmission buffer
14, 412 Transmission unit
15, 491 Data amount initial setting unit
16, 492 Data amount updating unit
17, 493 Data transmission suppression unit
200 Proxy server device
210 Reception-side NIC unit
220 TCP module unit
230 Proxy process unit
240 Transmission-side NIC unit
300 Client device
901 Global network
902 Mobile network

This application is based upon and claims the benefit of priority from Japanese patent application No. 2015-188491, filed Sep. 25, 2015 the disclosure of which is incorporated herein in its entirety by reference.

### INDUSTRIAL APPLICABILITY

The present invention may be applied to a data communication device, a method for controlling data communication, and a program.

What is claimed is:

1. A data communication device comprising:
a reception unit that receives data from a transmission device;
a transmission unit that transmits the data to a reception device;
a setting unit that sets, when the reception unit starts to receive the data, an amount of the data received by the reception unit to an amount that is independent from a transmission speed of the data from the transmission unit to the reception device;
an updating unit that updates the set amount to an amount that corresponds to the transmission speed after the reception unit has received the set amount of the data; and
a suppression unit that interrupts the transmission device from transmitting the data until the transmission unit transmits the updated amount of the data after the reception unit has received the updated amount of the data.

2. The data communication device according to claim 1, further comprising:
a reception buffer that stores data received by the reception unit; and
a transmission buffer that stores data awaiting transmission by the transmission unit.

3. The data communication device according to claim 1,
wherein the updating unit updates an amount of data received by the reception unit to an amount corresponding to the transmission speed, each time the updated amount of the data is received by the reception unit and transmitted by the transmission unit, and
the suppression unit interrupts the transmission device from transmitting the data until the transmission unit transmits the updated amount of the data after the reception unit has received the updated amount of the data, each time the updating unit has updated the amount of data received by the reception unit.

4. A method for controlling data communication, comprising:
receiving, by a reception unit, data from a transmission device;
transmitting, by a transmission unit, the data to a reception device;
setting, when the reception unit starts to receive the data, an amount of the data received by the reception unit to an amount that is independent from a transmission speed of the data from the transmission unit to the reception device;
updating the set amount to an amount that corresponds to the transmission speed after the reception unit has received the set amount of the data; and
interrupting the transmission device from transmitting the data until the transmission unit transmits the updated amount of the data after the reception unit has received the updated amount of the data.

5. A non-transitory computer-readable recording medium storing a program for a computer that controls a data communication device, the data communication device comprising a reception unit that receives data from a transmission device and a transmission unit that transmits the data to a reception device, the program causing the computer to execute:
setting, when the reception unit starts to receive the data, an amount of the data received by the reception unit to an amount that is independent from a transmission speed of the data from the transmission unit to the reception device;
updating the set amount to an amount that corresponds to the transmission speed after the reception unit has received the set amount of the data; and
interrupting the transmission device from transmitting the data until the transmission unit transmits the updated amount of the data after the reception unit has received the updated amount of the data.
